(19) United States
(12) Patent Application Publication
(10) Pub. No.: US 2025/0348843 A1
(43) Pub. Date: Nov. 13, 2025

(54) AGREEMENT DETERMINATION DEVICE, AGREEMENT DETERMINATION METHOD, AND STORAGE MEDIUM

(71) Applicant: NEC Corporation, Tokyo (JP)

(72) Inventor: Tomohito ANDO, Tokyo (JP)

(73) Assignee: NEC Corporation, Tokyo (JP)

(21) Appl. No.: 19/185,480

(22) Filed: Apr. 22, 2025

(30) Foreign Application Priority Data
May 9, 2024 (JP) 2024-076391

(51) Int. Cl. G06Q 10/101

(52) U.S. Cl. CPC G06Q 10/101

(57) ABSTRACT

The agreement determination device 1X mainly includes a proposal acquisition means 32X and an agreement determination means 33X. The proposal acquisition means 32X acquires a second proposal provided by a second negotiator as an alternative to a first proposal provided by a first negotiator who conducts a negotiation with the second negotiator. Upon determining that the second proposal is more favorable for the first negotiator than a base proposal on which the negotiation is based, the agreement determination means 33X determines that the second proposal is a tentative agreement proposal which is tentatively agreed between the first negotiator and the second negotiator.

### INCORPORATION BY REFERENCE

This application is based upon and claims the benefit of priority from Japanese Patent Application No. 2024-076391, filed on May 9, 2024, the disclosure of which is incorporated herein in its entirety by reference.

### TECHNICAL FIELD

The present disclosure relates to a technical field of an agreement determination device, an agreement determination method, and a storage medium.

### BACKGROUND

A system is known in which automatic negotiations on the condition adjustment between an orderer and a contractor is performed. For example, Patent Literature 1 discloses an automatic negotiation system configured to previously store proposals for negotiations according to possible orders from the orderer and then preferentially select a proposal having the largest utility with respect to the terms and conditions of negotiations received from the orderer to transmit the selected proposal to the orderer.

### CITATION LIST

### Patent Literature

Patent Literature 1: WO2021/024414

### SUMMARY

In general, if there are unacceptable points in the offer supplied from the counterparty, the offer will not be agreed. Once the negotiations have broken down, the next negotiations will be substantially started all over again from the state prior to the negotiations.

In view of the above-described issues, one object of the present disclosure is to provide an agreement determination device, an agreement determination method, and a storage medium capable of suitably reducing the burden of the next negotiations.

In an example aspect of the present disclosure, there is provided an agreement determination device including:

a proposal acquisition means configured to acquire a second proposal provided by a second negotiator as an alternative to a first proposal provided by a first negotiator who conducts a negotiation with the second negotiator; and

an agreement determination means configured to, upon determining that the second proposal is more favorable for the first negotiator than a base proposal on which the negotiation is based, determine that the second proposal is a tentative agreement proposal which is tentatively agreed between the first negotiator and the second negotiator.

In an example aspect of the present disclosure, there is provided an agreement determination method executed by a computer, including:
acquiring a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determining that the second proposal is a tentative agreement proposal which is tentatively agreed between the first negotiator and the second negotiator.

In an example aspect of the present disclosure, there is provided a program executed by a computer, the program causing the computer to:
acquire a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determine that the second proposal is a tentative agreement proposal which is tentatively agreed between the first negotiator and the second negotiator.

An example advantage according to the present disclosure is to suitably reduce the burden of the next negotiations.

### BRIEF DESCRIPTION OF THE DRAWINGS

FIG. 1 illustrates a configuration of the negotiation system.

FIG. 2 illustrates the hardware configuration of the platform providing device.

FIG. 3 illustrates the hardware configuration of the terminal device.

FIG. 4 illustrates an example of functional blocks in the negotiation platform.

FIG. 5 illustrates an example of an agreement confirmation screen image regarding the agreement/disagreement of the offer.

FIG. 6 illustrates an example of a tentative agreement confirmation screen image regarding the determination of a tentative agreement offer.

FIG. 7 illustrates an example of an agreement/a tentative agreement confirmation screen image.

FIG. 8 illustrates an example of an offer edit screen image.

FIG. 9 illustrates an example of a negotiation result screen image.

FIG. 10 illustrates an example of a flowchart executed by the platform providing device.

FIG. 11 illustrates the configuration of the negotiation system.

FIG. 12 illustrates a functional block diagram of an agreement determination device.

FIG. 13 illustrates an example of a flowchart showing a processing procedure of the agreement determination device.

### EXAMPLE EMBODIMENTS

Hereinafter, example embodiments of an agreement determination device, an agreement determination method, and a storage medium will be described with reference to the drawings.

In the following explanation, the term “negotiation” refers to an adjustment of terms and conditions until the conclusion of an agreement between a party that places an order and a party that receives an order. In this example embodiment, the term “negotiations” mainly indicates actions taken by the parties to alternatively offer and counteroffer a proposal (also referred to as “offer”) for the agreement on the terms and conditions of the order. The negotiations in this case may be negotiations between parties with conflicting interest or may be negotiations (so-called adjustment) between parties without conflicting interest. Negotiations also include not only negotiations on general orders in which purchase orders are issued, but also adjustments to expected delivery quantities, etc., without issuing purchase orders. Also, examples of target terms and conditions (so-called issue) of negotiations include prices of products, due dates, quantities, means of transportation, resources (airspace if a drone is used as means of transportation), functions, and qualities. The term “negotiator” also refers to a subject that is responsible for placing an order and receiving an order, and has, for example, the ability to provide a proposal for agreement to the other negotiator, and the ability to determine whether or not to agree on the offer supplied from the other negotiator. The negotiator may be an individual or may be an organization. The negotiator may negotiate using an AI, a robotics, or any other device (including a drone and an autonomous vehicle) to reflect the intention of the individual or organization.

### First Example Embodiment

### (1) System Configuration

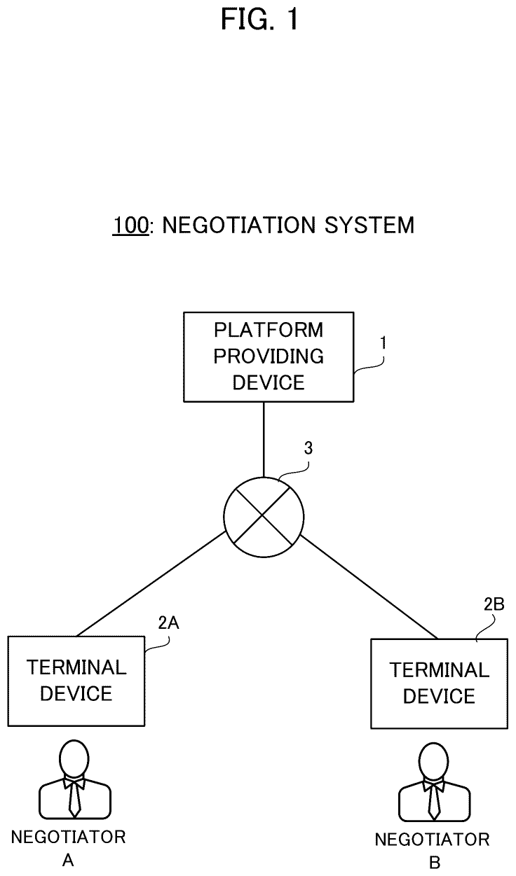

FIG. 1 illustrates the configuration of a negotiation system 100. The negotiation system 100 mainly includes a platform providing device 1 that provides an electronic negotiation platform for negotiating terms and conditions, and a terminal device 2A and a terminal device 2B that are used by negotiators that conduct negotiations on the negotiation platform provided by the platform providing device 1. The platform providing device 1, the terminal device 2A, and the terminal device 2B perform data communication via the network 3 with one another. In FIG. 1, as an example, a terminal device 2A usable by the negotiator A, and a terminal device 2B usable by the negotiator B are illustrated, and hereafter, when the terminal device 2A and the terminal device 2B are not particularly distinguished, these are simply referred to as “terminal device 2”.

Hereinafter, the negotiations between the negotiator A and the negotiator B on a one-to-one basis will be described as an example. It is noted that negotiations with competitive quotes, total amount negotiations, nested negotiations may be performed by combining a plurality of one-to-one basis negotiations to be described below.

The platform providing device 1 provides a negotiation platform required for negotiations on the terms and conditions between the negotiator A and the negotiator B through the terminal device 2A and the terminal device 2B. For example, the negotiator who places an order is a manufacturer of products, and the negotiator who receives the order is a supplier who supplies components (parts) necessary for the manufacture of the products. The platform providing device 1 generates display information required for display of information required for negotiations, and transmits the generated display information to the terminal device 2A and the terminal device 2B to control the display of the terminal device 2A and the terminal device 2B. In this instance, the platform providing device 1 receives the input information related to the offer from the terminal device 2A and the terminal device 2B and generates the above-described display information based on the received input information. The platform providing device 1 is an example of the “agreement determination device”.

The terminal device 2 (2A, 2B) are communication devices used by the negotiators, and, on the basis of the data communication with the platform providing device, displays the information or accepts the input from the negotiators. In the present example embodiment, as an example, the negotiator A shall conduct automated negotiations through a negotiation AI (the description of the negotiation AI will be given later) in principle, and the negotiator B shall conduct negotiations (hereinafter, also referred to as “manual-based negotiations”) based on a manual input through the terminal device 2B without using any negotiation AI. It is noted that upon determining that the automated negotiations by the negotiation AI does not lead to an agreement, or upon determining, in other cases, that manual-based negotiations are required, the negotiator A can switch to the manual-based negotiations based on the input through the terminal device 2A.

The configuration of the negotiation system 100 shown in FIG. 1 is an example, and various changes may be made to the configuration. For example, the platform providing device 1 may be configured by a plurality of devices. In this case, the plurality of devices constituting the platform providing device 1 performs transmission and reception of information necessary for executing the pre-allocated process among the plurality of devices.

### (2) Hardware Configuration

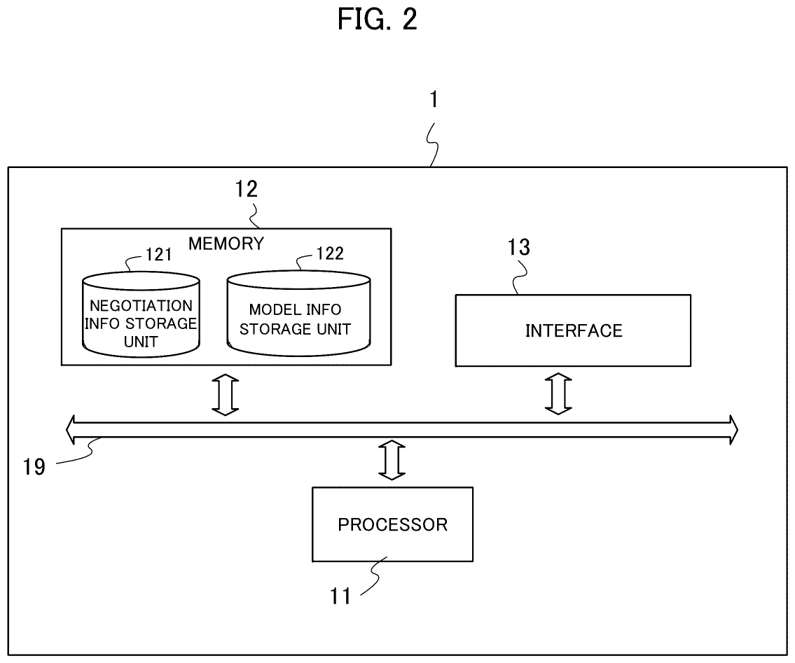

FIG. 2 shows the hardware configuration of the platform providing device 1. The platform providing device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories and non-volatile memories such as a RAM (Random Access Memory) and a ROM (Read Only Memory). The memory 12 further stores a program for executing various process by the platform providing device 1. The memory 12 is also used as a working memory.

The memory 12 functionally includes a negotiation information storage unit 121 and a model information storage unit 122.

The negotiation information storage unit 121 stores negotiation information which is information relating to the negotiations between the negotiator A and the negotiator B. The negotiation information includes information on an offer (including a tentative agreement offer which will be described later) currently-agreed between negotiator A and negotiator B. For example, order numbers are assigned to products subject to orders according to the types of the products, and the offer indicates a proposal (draft) of terms and conditions relating to plural order numbers.

The model information storage unit 122 stores model information (including parameters) for configuring a negotiation AI which is an artificial intelligence model for negotiating with the other negotiator as an agent for the negotiator. The negotiation AI is utilized for negotiating with the other negotiator (here, negotiator B) by the negotiator A which is an individual or an organization.

The negotiation AI include an acceptance strategic function that makes a determination (so-called acceptance determination) as to whether or not to agree on an offer provided by the other negotiator, and an offer generation function that generates an offer. Examples of the offer generation include the generation of an alternative offer (also referred to as “counteroffer”) upon determining that the offer provided by the other negotiator cannot be agreed upon. Any technique may be used to generate an offer, such as beam search, grid search, search by probabilistic optimization such as a genetic algorithm, search by Bayesian optimization, and a combination thereof. In some embodiments, the negotiation AI may calculate the utility (degree of utility) using the utility function for calculating the degree of goodness of the offer, and then, based on the utility, makes the acceptance determination as to the offer supplied from the other negotiator and determines an offer to provide with the other negotiator. For example, the negotiation AI may decide to accept an offer whose utility is greater than or equal to a predetermined threshold value, and may decide not to accept an offer whose utility is less than the above-mentioned threshold value. The negotiation AI may also make plural options for an offer, and determine the offer by selecting the option having the highest utility to notify the other negotiator. It is noted that a method of determining an offer based on a utility function is disclosed in, for example, Patent Literature 1.

The interface 13 is one or more interfaces for electrically connecting the platform providing device 1 to other devices. Examples of the interfaces include a wireless interface, such as network adapters, for transmitting and receiving data to and from other devices wirelessly, and a hardware interface, such as a cable, for connecting to other devices.

The hardware configuration of the platform providing device 1 is not limited to the configuration shown in FIG. 2. For example, the platform providing device 1 may include at least one of an input device, a display device, and/or a sound output device. At least a portion of the information stored in the memory 12 may be stored in one or more storage devices other than the platform providing device 1. In this case, examples of the storage devices include a hard disk connected to the platform providing device 1, a storage medium such as a flash memory, and a server device that performs data communication with the platform providing device 1.

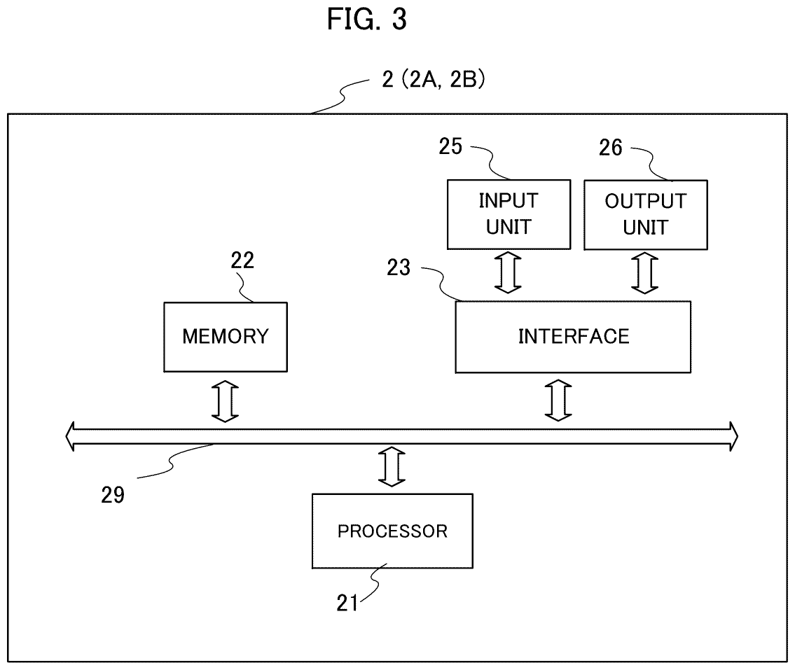

FIG. 3 shows the hardware configuration of the terminal device 2, that is, the hardware configuration common to the terminal device 2A and the terminal device 2B. The terminal device 2 includes a processor 21, a memory 22, and an interface 23 as hardware. The processor 21, memory 22, and interface 23 are connected to one another via a data bus 29.

The processor 21 executes a predetermined process by executing a program stored in the memory 22. Examples of the processor 21 is a processor such as a CPU, a GPU, and a TPU. The processor 21 may be configured by a plurality of processors. The processor 21 is an example of a computer.

The memory 22 is configured by various volatile memories and non-volatile memories such as a RAM (Random Access Memory) and a ROM (Read Only Memory). Further, in the memory 22, a program for executing various processes by the platform providing device 1 is stored. The memory 22 is also used as a working memory.

The interface 23 is one or more interfaces for electrically connecting the terminal device 2 to other devices. Examples of the interfaces include a wireless interface, such as a network adapter, for transmitting and receiving data to and from other devices wirelessly, and a hardware interface, such as a cable, for connecting to other devices.

The interface 23 performs the interface operation of the input unit 25 and the output unit 26. The input unit 25 is a user interface that receives an input that is an external input, and examples of the input unit 25 include a touch panel, a button, a keyboard, and a voice input device. The interface 23 supplies the input signal generated by the input unit 25 to other components in the terminal device 2 or a device existing outside the platform providing device 1. The output unit 26 performs display or audio output of predetermined information based on the output signal supplied through the interface 23. Examples of the output unit 26 include a display, a projector, and an audio output device.

The hardware configuration of the terminal device 2 is not limited to the configuration shown in FIG. 3. For example, at least one of the input unit 25 and/or the output unit 26 may be configured separately from the terminal device 2.

### (3) Processing on Negotiation Platform

Next, a description will be given of the processing on the negotiation platform by the platform providing device 1. In summary, once a counteroffer is supplied to the negotiator which provided an offer, the platform providing device 1 determines whether or not to set the counteroffer as a tentatively agreed offer (also referred to as “tentative agreement offer”) between the negotiators. Thus, by setting a tentative agreement offer in this way, the platform providing device 1 suitably reduces the burden in the next negotiations even when the negotiations are suspended due to switching from automated negotiations by the negotiation AI to the manual-based negotiations.

In the determination of a tentative agreement, upon determining that the counteroffer is more favorable in the terms and conditions for the negotiator who provided the offer than an offer (referred to as “base offer”) on which the negotiations are based, the platform providing device 1 determines that the counteroffer is a tentative agreement offer. The base offer is the latest offer deemed to be agreed or tentatively agreed between the negotiators. Specifically, the base offer refers to the latest tentative agreement offer if there are already tentative agreement offer(s). If there is no tentative agreement offer, the base offer refers to an offer that was agreed or tentatively agreed in the previous negotiations and stored as negotiation information in the negotiation information storage unit 121.

Supplementary explanation is given herein on the advantages of setting a tentative agreement offer.

Negotiations such as a delivery time adjustment of parts that could occur on a daily-basis among manufacturers cannot be left as it is after the breakdown of the negotiations to avoid the risk of missing parts. Therefore, when the automated negotiations are broken down, it is necessary for the negotiator to take over the negotiations. On the other hand, as long as there is a non-agreed point that cannot reach a mutual agreement, the negotiations as a whole do not come to an agreement. If the agreement is not reached by automated negotiations, then it is often the case that the negotiator takes over the negotiations and performs manual-based negotiations. Unfortunately, in this case, since it cannot be said that there has been progress in the automated negotiations, the negotiator will substantially start the manual-based negotiations all over again from the state prior to the automated negotiations.

In view of the above, the platform providing device 1 in the present example embodiment provides a negotiation platform in which a tentative agreement can be made. In this way, when a person takes over the negotiations, the person can start the negotiations from the state where the negotiations are advanced, thus reducing the burden of negotiations. For example, in the case of automated negotiations made for the delivery date of products, even if the automated negotiations are finished in a state where an agreement cannot be made in terms of the delivery date of the product in the future order, the next negotiations can get started in the state where a tentative agreement is made by the automated negotiations in terms of the delivery date in the upcoming order. Thus, since the person in charge of negotiations taking over the automated negotiation only has to negotiate the part (future order) unagreed in the automated negotiation, the burden of the negotiations is suitably reduced. In other words, there is such an advantage in the negotiation system in the example embodiment that setting a tentative agreement on an offer can be available, compared to a conventional negotiation platform with only two choices of whether to agree on the entire offer or not. Thus, the negotiation platform in the example embodiment can suitably reduce the burden of the next negotiations.

### (3-1) Functional Blocks

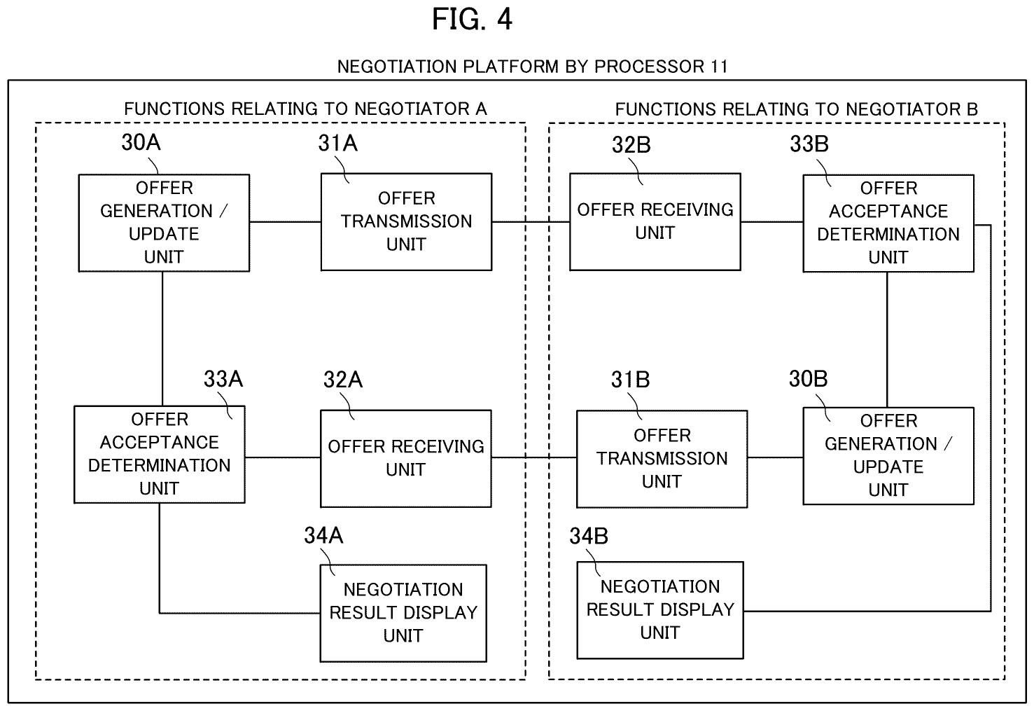

FIG. 4 is an example of a functional block in a negotiation platform implemented by the processor 11 of the platform providing device 1. The negotiation platform includes an offer generation/update unit 30A, an offer transmission unit 31A, an offer receiving unit 32A, an offer acceptance determination unit 33A, and a negotiation result display unit 34A as functions relating to the negotiator A. The negotiation platform includes an offer generation/update unit 30B, an offer transmission unit 31B, an offer receiving unit 32A, an offer acceptance determination unit 33B, and a negotiation result display unit 34B as functions relating to the negotiator B. In FIG. 4, blocks to exchange data with each other are connected by a solid line, but the combination of the blocks to exchange data with each other is not limited thereto. The same applies to the drawings of other functional blocks described below.

First, the functions relating to the negotiator A will be described.

The offer generation/update unit 30A generates and updates an offer by the negotiation AI. The term “updating an offer” refers to generating a counteroffer upon determining that an offer supplied from the negotiator B is unacceptable. In this case, for example, the processor 11 configures the negotiation AI referring to the model information stored in the model information storage unit 122 and executes the process related to the offer generation/update unit 30A. The negotiation AI generates an offer based on the negotiation information and the like stored in the negotiation information storage unit 121. Upon receiving, from the offer acceptance determination unit 33A, the latest offer and the determination result indicating the refusal of the offer, the negotiation AI updates the received offer. The offer generation/update unit 30A supplies the generated or updated offer to the offer transmission unit 31A.

The offer transmission unit 31A supplies information indicating the offer generated or updated by the offer generation/update unit 30A to the offer receiving unit 32B. For example, the processor 11 functions as an offer transmission unit 31A to generate display information for displaying the offer generated or updated by the offer generation/update unit 30A on the terminal device 2B. Then, the processor 11 transmits the generated display information to the terminal device 2B through the interface 13.

The offer receiving unit 32A receives information indicating an offer supplied from the offer transmission unit 31B, which will be described later. In this case, for example, the processor 11 functions as an offer receiving unit 32A and receives information indicating an offer supplied from the offer transmission unit 31B to be described later.

The offer acceptance determination unit 33A determines whether or not to accept (i.e., agree on) the offer which the offer receiving unit 32A has received. Upon determining that the offer is not acceptable, the offer acceptance determination unit 33A makes a determination as to a tentative agreement offer. In this case, for example, the processor 11 configures the negotiation AI with reference to the model information stored in the model information storage unit 122 and executes the process related to the offer acceptance determination unit 33A.

A description will be given of the determination as to a tentative agreement offer. Upon determining that the offer received by the offer receiving unit 32A is not acceptable and is a counteroffer against the offer generated by the offer generation/update unit 30A, the offer acceptance determination unit 33A determines whether or not the counteroffer is a tentative agreement offer. In the case where the negotiator A is a first negotiator who has proposed an offer (i.e., the negotiator A made the offer), the offer acceptance determination unit 33A makes the determination as to the tentative agreement offer whenever the offer receiving unit 32A receives an offer from the negotiator B except when the offer comes to an agreement.

The offer acceptance determination unit 33A identifies the base offer by referring to the negotiation information stored in the negotiation information storage unit 121, and determines that the counteroffer is a tentative agreement offer upon determining that the counteroffer is more favorable for the negotiator A than the base offer. On the other hand, upon determining that the counteroffer is not more favorable for the negotiator A than the base offer, the offer acceptance determination unit 33A determines that the counteroffer is not a tentative agreement offer.

Here, the base offer is the latest tentative agreement offer stored in the negotiation information storage unit 121, or the offer indicated by the negotiation information stored in the negotiation information storage unit 121 if there is no tentative agreement offer. In this case, the offer indicated by the negotiation information stored in the negotiation information storage unit 121 is deemed to be agreed or tentatively agreed in the previous negotiation and stored in the negotiation information storage unit 121 at the start of the ongoing negotiations.

In a comparison in superiority or inferiority between a base offer and a counteroffer, the offer acceptance determination unit 33A may make a comparison between them using any criterion. For example, the offer acceptance determination unit 33A calculates a utility (degree of utility) on the assumption that a base offer is employed and a utility on the assumption that a counteroffer is employed, respectively. Then, if the utility on the assumption that a counteroffer is employed is higher than the utility on the assumption that a base offer is employed, the offer acceptance determination unit 33A determines that the counteroffer is more favorable in the terms and conditions for the negotiator A than the base offer. In this instance, the offer acceptance determination unit 33A determines that the counteroffer is a tentative agreement offer. In contrast, if the utility on the assumption that a counteroffer is employed is equal to or lower than the utility on the assumption that a base offer is employed, the offer acceptance determination unit 33A determines that the counteroffer is not favorable in the terms and conditions for the negotiator A than the base offer. In this instance, the offer acceptance determination unit 33A determines that the counteroffer is not a tentative agreement offer.

A description will be given of the process to be performed by the offer acceptance determination unit 33A after the acceptance determination of the offer and the determination of the tentative agreement offer.

Upon determining that the offer received by the offer receiving unit 32A is acceptable, the offer acceptance determination unit 33A supplies information (i.e., information indicating the offers received by the offer receiving unit 32A) indicating the agreed offer to the negotiation result display unit 34A. The offer acceptance determination unit 33A may also provide the negotiation result display unit 34B with information indicating the agreed offer.

Upon determining that the offer received by the offer receiving unit 32A is not acceptable, but the offer is a tentative agreement offer, the offer acceptance determination unit 33A stores, in the negotiation information storage unit 121, information on the offer determined to be a tentative agreement offer. The latest tentative agreement offer stored in the negotiation information storage unit 121 is used as a base offer in the next negotiations. This tentative agreement offer is also used as a base offer in the next negotiations even if the ongoing negotiations are suspended.

Upon determining that the offer received by the offer receiving unit 32A is not acceptable and it is necessary to switch to the manual-based negotiations, the offer acceptance determination unit 33A supplies information indicating the offer at the present time to the negotiation result display unit 34A. The offer acceptance determination unit 33A may supply the above-described information to the negotiation result display unit 34B in the same manner. For example, the offer acceptance determination unit 33A needs to switch to manual-based negotiations upon determining the offer which the offer receiving unit 32A received at the last time has no change (i.e., the negotiations are not advanced) from the offer which the offer receiving unit 32A received at the last but one time. In another instance, upon receiving a request for the suspension of negotiations from the negotiator B, the offer acceptance determination unit 33A determines that the negotiations should be switched to manual-based negotiations.

On the other hand, upon determining that the offer which the offer receiving unit 32A has received is not acceptable and there is no need to switch to manual-based negotiations, the offer acceptance determination unit 33A supplies the information indicating the received offer and the determination result indicating that the offer cannot be accepted to the offer generation/update unit 30A. The offer acceptance determination unit 33A determines that there is no need to switch to manual-based negotiations if there is a substantial variation between the last offer received by the offer receiving unit 32A and the last but one offer received by the offer receiving unit 32A. In another instance, the offer acceptance determination unit 33A determines that it is not necessary to switch to manual-based negotiations if there is no request for suspension of negotiations from the negotiator B.

The negotiation result display unit 34A displays on the terminal device 2A the negotiation result based on the information received from the offer acceptance determination unit 33A. In this instance, the processor 11 functions as the negotiation result display unit 34A to generate display information based on the information received from the offer acceptance determination unit 33A and supplies the generated display information to the terminal device 2A. For example, if the offer is agreed, the negotiation result display unit 34A displays on the terminal device 2A the information on the agreed offer based on the information received from the offer acceptance determination unit 33A.

On the other hand, if the offer has not been agreed but a tentative agreement offer has been determined by the offer acceptance determination unit 33A, the negotiation result display unit 34A causes the terminal device 2A to display information indicating the latest tentative agreement offer. This will cause the negotiator A to confirm the latest tentative agreement offer on which the next negotiations are based.

In some embodiment, the negotiation result display unit 34A may display the negotiation result based on the information received from the offer acceptance determination unit 33B or the like on the terminal device 2A once the offer acceptance determination unit 33B has determined that the negotiations should be suspended. In addition, if the offer acceptance determination unit 33B, which will be described later, determines a tentative agreement offer, the negotiation result display unit 34A may display information indicating the latest tentative agreement offer on the terminal device 2A and accept a user input through the terminal device 2A as to whether or not to agree on the tentative agreement offer. In this case, upon receiving the input information indicating disagreement on the tentative agreement offer from the terminal device 2A, the negotiation result display unit 34A may delete the information regarding the tentative agreement offer from the negotiation information storage unit 121. The negotiation result display unit 34A is an example of the display control unit.

Next, a description will be given of the function relating to the negotiator B.

The offer receiving unit 32B receives information indicating the offer supplied from the offer transmission unit 31A. In this case, for example, the terminal device 2B functions as an offer receiving unit 32B under the control of the processor 11, and receives information indicating an offer supplied from the offer transmission unit 31A through the interface 23.

The offer acceptance determination unit 33B determines, based on the information input by the negotiator B, whether or not to accept (i.e., agree on) the offer received by the offer receiving unit 32B. In addition, upon determining that the offer is not acceptable, the offer acceptance determination unit 33B makes, based on information inputted from the negotiator B, a determination as to the tentative agreement offer. In this case, the processor 11 functions as the offer acceptance determination unit 33B by controlling the terminal device 2B.

In the acceptance determination of the offer, under the control of the processor 11, the terminal device 2B displays the offer provided by the negotiator A based on the information received by the offer receiving unit 32B to receive a user input for specifying whether or not agree on the offer and whether or not to suspend the negotiations. Then, the terminal device 2B transmits the received input information to the platform providing device 1, and the processor 11 determines whether or not to accept (i.e., agree on) the offer on the basis of the input information received from the terminal device 2B.

In the determination as to the tentative agreement offer, upon determining that the offer received by the offer receiving unit 32B is not acceptable but is a counteroffer against the offer generated by the offer generation/update unit 30B, the offer acceptance determination unit 33B determines whether or not the counteroffer is a tentative agreement offer. In the case where the negotiator B is a first negotiator who has proposed an offer (i.e., the negotiator B made the offer), the offer acceptance determination unit 33B makes the determination as to the tentative agreement offer whenever the offer receiving unit 32B receives an offer from the negotiator A except when the offer comes to an agreement. Upon determining, based on the information input from the negotiator B, that the counteroffer is more favorable for the negotiator B than the base offer, the offer acceptance determination unit 33B determines that the counteroffer is a tentative agreement offer. On the other hand, upon determining, based on the information input from the negotiator B, that the counteroffer is not more favorable for the negotiator B than the base offer, the offer acceptance determination unit 33B determines that the counteroffer is not a tentative agreement offer.

Under the control of the processor 11, the terminal device 2B displays the base offer stored in the negotiation information storage unit 121 and the counteroffer proposed by the negotiator A based on the information received by the offer receiving unit 32B. Then, the terminal device 2B receives a user input that specifies whether or not the counteroffer is more favorable for the negotiator B than the base offer. The terminal device 2B transmits the received input information to the platform providing device 1, and the processor 11 determines, based on the input information received from the terminal device 2B, whether or not the counter offer is a tentative agreement offer. This specific embodiment will be described later with reference to the display example.

Upon determining that the offer has come to an agreement, the offer acceptance determination unit 33B supplies the information indicating the agreed offer (i.e., information indicating the offer received by the offer receiving unit 32B) to the negotiation result display unit 34B.

In addition, upon determining that the offer received by the offer receiving unit 32B is not acceptable but the offer is a tentative agreement offer, the offer acceptance determination unit 33B stores information indicating the offer deemed to be a tentative agreement offer in the negotiation information storage unit 121. The latest tentative agreement offer stored in the negotiation information storage unit 121 is used as a base offer in the ongoing negotiations. This tentative agreement is also used as a base offer in the next negotiations, even if the ongoing negotiations are suspended.

Upon determining that there is no agreement on the entire offer and that there is an input specifying the suspension of the negotiations, the offer acceptance determination unit 33B determines that the negotiations should be suspended and supplies the information indicating the current offer to the negotiation result display unit 34B. The offer acceptance determination unit 33B may supply the information not only to the negotiation result display unit 34B but also to the negotiation result display unit 34A. Upon determining that there is no agreement on the offer and there is no input specifying the suspension of the negotiations, the offer acceptance determination unit 33B supplies the information indicating the offer and the determination result indicating that the offer is not acceptable to the offer generation/update unit 30B.

The offer generation/update unit 30B generates and updates the offer. In this case, the processor 11 functions as the offer generation/update unit 30B by controlling the terminal device 2B. For example, upon receiving the determination result indicating that the offer is not acceptable from the offer acceptance determination unit 33B, the offer generation/update unit generates a counteroffer based on input from the negotiator B. The terminal device 2B receives the input specifying the counteroffer and transmits the received input information to the platform providing device 1. The offer generation/update unit 30B may generate a new offer based on the input information received at any timing.

The offer transmission unit 31B supplies information indicating the offer generated or updated by the offer generating/update unit 30B to the offer receiving unit 32A. For example, the processor 11 functions as the offer transmission unit 31B.

The negotiation result display unit 34B displays on the terminal device 2B the negotiation result based on the information received from the offer acceptance determination unit 33B. In this instance, the processor 11 functions as the negotiation result display unit 34B to generate display information based on the information received from the offer acceptance determination unit 33B and supplies the generated display information to the terminal device 2B. For example, if the offer has come to an agreement, the negotiation result display unit 34B displays the information on the agreed offer on the terminal device 2B based on the information received from the offer acceptance determination unit 33B.

On the other hand, upon determining that the offer is not acceptable and there is a tentative agreement offer determined by the offer acceptance determination unit 33B, the negotiation result display unit 34B displays information on the latest tentative agreement offer on the terminal device 2B. This will cause negotiator B to confirm the latest tentative agreement offer on which the next negotiations will be based. In this way, if the negotiations are suspended, the platform providing device 1 causes both the terminal device 2A and the terminal device 2B to display the latest tentative agreement offer.

In some embodiments, the negotiation result display unit 34B may display the negotiation result based on the information received from the offer acceptance determination unit 33A or the like on the terminal device 2B once the offer acceptance determination unit 33A makes the determination of the suspend of the negotiations. In addition, if the offer acceptance determination unit 33A determines a tentative agreement offer, the negotiation result display unit 34B may display information indicating the latest tentative agreement offer on the terminal device 2B and accept a user input through the terminal device 2B as to whether or not to agree on the tentative agreement offer. In this case, upon receiving the input information indicating disagreement on the tentative agreement offer from the terminal device 2B, the negotiation result display unit 34B may delete the information regarding the tentative agreement offer from the negotiation information storage unit 121. The negotiation result display unit 34B is an example of the display control unit.

The respective components of the offer generation/update unit 30A, the offer transmission unit 31A, the offer acceptance determination unit 33A, the negotiation result display unit 34A, the offer generation/update unit 30B, the offer transmission unit 31B, the offer acceptance determination unit 33B, and the negotiation result display unit 34B described in FIG. 4 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (3-2) Display Examples

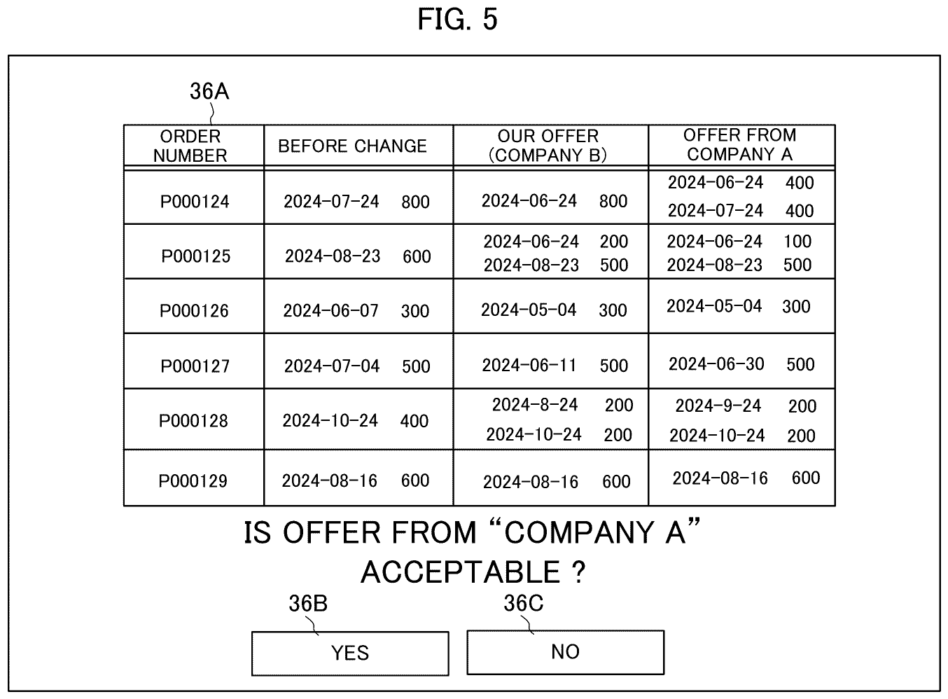

Next, a description will be given of specific examples of the information displayed by the terminal device 2B with respect to the offer with reference to FIGS. 5 to 8.

FIG. 5 is an example of an agreement confirmation screen image regarding agreement/disagreement on an offer. Here, the negotiator B (here referred to as “Company B”) proposes a first offer, and then the negotiator A (here referred to as “Company A”) provides a counteroffer which is a counter proposal against the first offer. The platform providing device 1 causes the terminal device 2B to display the agreement confirmation screen image for designating agreement/disagreement on the counteroffer. In this case, the platform providing device 1 generates the display information based on the counteroffer proposed by the negotiator A and transmits the display information to the terminal device 2B, thereby causing the terminal device 2B to display the agreement confirmation image shown in FIG. 5 based on the display information.

On the agreement confirmation screen image shown in FIG. 5, the platform providing device 1 provides an offer display table 36A together with an affirmative button 36B and a negative button 36C which are graphical user interfaces (GUI: Graphical User Interface) for specifying whether or not to accept an offer. These buttons are not limited to the illustrated mode, and may be realized by any mode. Any button provided on any other screen image is not limited to the illustrated mode, and may be realized by any mode.

The offer display table 36A includes records of orders for respective order numbers, and has items “ORDER NUMBER”, “BEFORE CHANGE”, “OUR OFFER (COMPANY B)”, and “OFFER FROM COMPANY A”. The item “ODER NUMBER” indicates the order number corresponding to each record. In addition to the order number, the identification information of the products corresponding to the order number (including product names and the like) may be further displayed therein. The item “BEFORE CHANGE” indicates the terms and conditions of the order number before the negotiator A proposes the offer. The item “OFFER FROM COMPANY A” indicates the offer from the negotiator A for each corresponding order number. Here, in the field of each item “BEFORE CHANGE”, “OUR OFFER (COMPANY B)”, and “OFFER FROM COMPANY A”, as an example, the due date (year-month-day) and quantity of products for each order number are displayed. Not only the due date (delivery date) and the quantity but also any terms and conditions such as price and transportation means may be further displayed.

Then, upon detecting that the affirmative button 36B for specifying acceptance of an offer has been selected, the platform providing device 1 determines that the negotiator B has agreed on the counteroffer from the negotiator A. On the other hand, upon detecting that the negative button 36C for specifying non-acceptance of an offer has been selected, the platform providing device 1 determines that the negotiator B has disagreed on the counteroffer from the negotiator A. In this case, the platform providing device 1 further displays the following tentative agreement confirmation screen image.

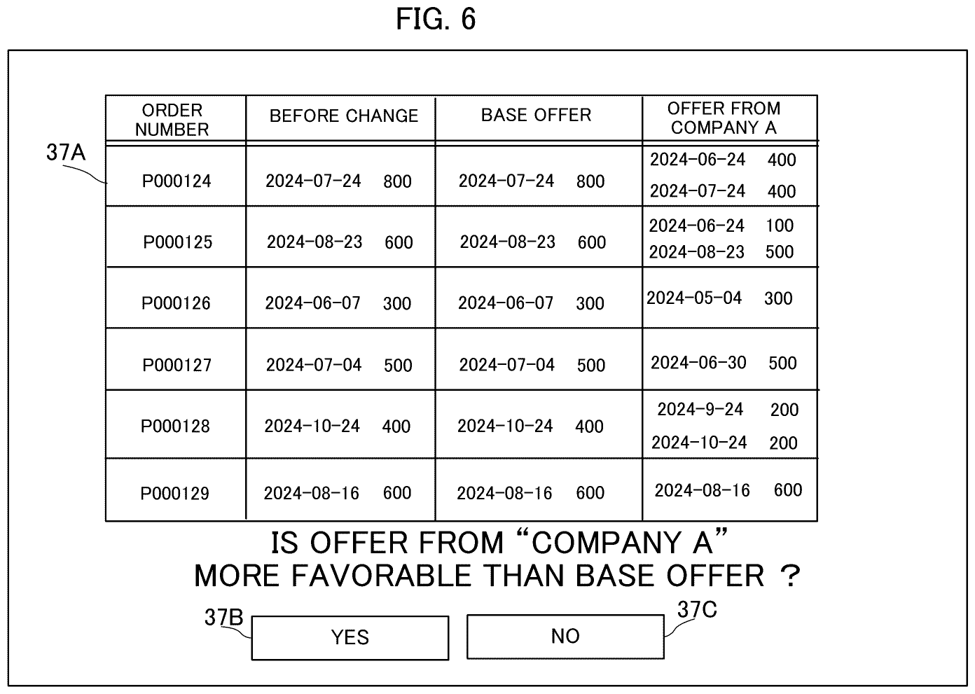

FIG. 6 is an example of a tentative agreement confirmation screen image for determining a tentative agreement offer. Upon detecting that the negative button 36C for specifying non-acceptance of an offer has been selected in the agreement confirmation screen image shown in FIG. 5, the platform providing device 1 displays the tentative agreement confirmation screen image shown in FIG. 6 on the terminal device 2B.

The platform providing device 1 provides, on the tentative agreement confirmation screen image shown in FIG. 6, the offer display table 37A in which a counteroffer and a tentative agreement offer are comparably displayed, and an affirmative button 37B and a negative button 37C, which are graphical user interfaces.

The offer display table 37A contains records of orders for respective order numbers, and includes items “ORDER NUMBER”, “BEFORE CHANGE”, “BASE OFFER”, and “OFFER FROM COMPANY A”. The items “ORDER NUMBER”, “BEFORE CHANGE”, and “OFFER FROM COMPANY A” respectively indicate the order number, the offer for each order number agreed or tentatively agreed in the previous negotiations, and the offer for each order number proposed by negotiator A, as indicated in the offer display table 36A shown in FIG. 5. The item “BASE OFFER” indicates a base offer for each order number. Here, the base offer is the offer indicated in the item “BEFORE CHAGE” (i.e., the offer agreed or tentatively agreed before the start of negotiations as stored in the negotiation information storage unit 121) because the tentative agreement offer does not yet exist in the ongoing negotiations. If one or more tentative agreement offers were already generated, then the item “BASE OFFER” would indicate the latest tentative agreement offer for each order number.

Then, upon detecting that the affirmative button 37B for affirming that the offer from the negotiator A is more desirable than the base offer has been selected, the platform providing device 1 determines that the offer from the negotiator A is better for the negotiator B than the base offer. Therefore, in this case, the platform providing device 1 determines that the offer of the negotiator A in the item “OFFER FROM COMPANY A” is a tentative agreement offer, and stores the offer as the latest tentative agreement offer in the negotiation information storage unit 121. On the other hand, if the platform providing device 1 detects that the negative button 37C for denying that the offer from the negotiator A is more desirable than the base offer has been selected, it determines that the offer from the negotiator A is not as good for the negotiator B as the base offer. Therefore, in this case, the platform providing device 1 determines that the offer from the negotiator A in the item “OFFER FROM COMPANY A” is not a tentative agreement offer and does not renew the base offer.

As described above, in the tentative agreement confirmation screen image shown in FIG. 6, the platform providing device 1 can suitably accept the input necessary to determine whether or not the counteroffer from the negotiator A is a tentative agreement offer.

The agreement confirmation screen image shown in FIG. 5 and the tentative agreement confirmation screen image shown in FIG. 6 may be realized by one screen image.

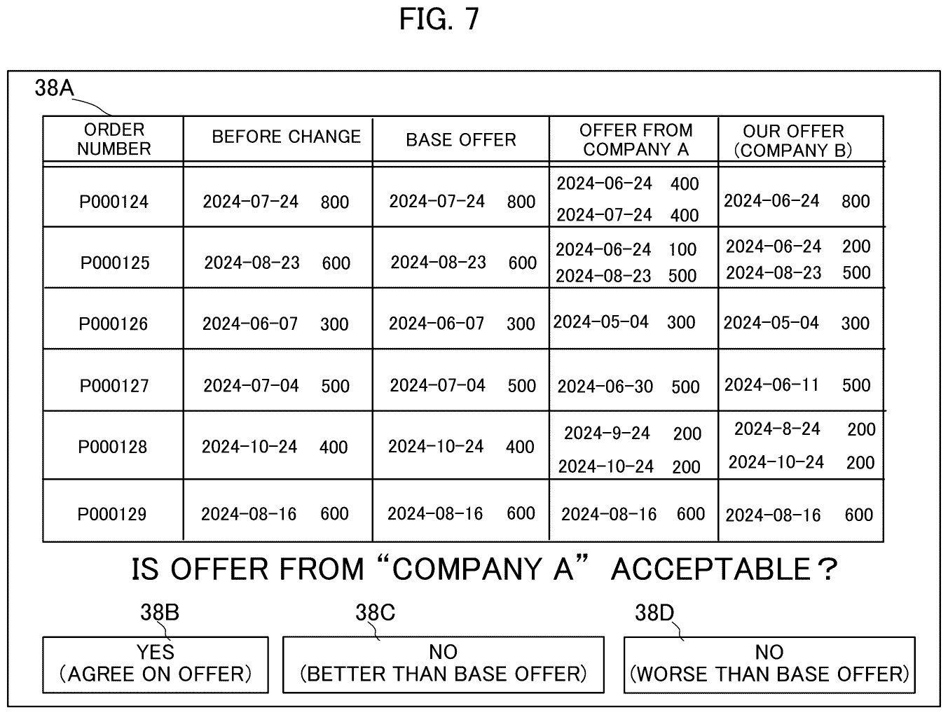

FIG. 7 is an example of an agreement/tentative agreement confirmation screen image into which the agreement confirmation screen image shown in FIG. 5 and the tentative agreement confirmation screen image shown in FIG. 6 are integrated.

On the agreement/tentative agreement confirmation screen image shown in FIG. 7, the platform providing device 1 provides an offer display table 38A, a first affirmative button 38B which is a graphical user interface, a second affirmative button 38C, and a negative button 38D.

The offer display table 38A contains records of orders for respective order numbers, and has items “ORDER NUMBER”, “BEFORE CHANGE”, “BASE OFFER”, “OFFER FROM COMPANY A”, and “OUR OFFER (COMPANY B)”. The items “ORDER NUMBER”, “BEFORE CHANGE”, “OFFER FROM COMPANY A”, and “OUR OFFER (COMPANY B)” indicate the order number, the terms and conditions for each order number before the negotiator B proposes the offer, the offer for each order number from the negotiator A, and the offers for each order number proposed by the negotiator B, respectively. These items are substantially the same as the items in the offer display table 36A shown in FIG. 5. The item “BASE OFFER” indicates the base offer for each order number, in the same way as in the offer indication table 37A shown in FIG. 6.

Upon detecting that the first affirmative button 38B has been selected, the platform providing device 1 determines that the negotiator B agrees on the counteroffer from the negotiator A. Upon detecting that the second affirmative button 38C has been selected, the platform providing device 1 determines that no agreement has been reached on the offer and that the offer of the negotiator A is better for the negotiator B than the base offer. Therefore, in this case, the platform providing device 1 determines that the offer from the negotiator A is a tentative agreement offer, and stores the offer as the latest tentative agreement offer in the negotiation information storage unit 121. On the other hand, if the platform providing device 1 detects that the negative button 38D has been selected, it determines that disagreement has been reached on the offer and that the offer from the negotiator A is not better for the negotiator B than the base offer. Therefore, in this case, the platform providing device 1 determines that the offer from the negotiator A in the item “OFFER FROM COMPANY A” is not a tentative agreement offer.

As described above, the platform providing device 1 preferably receives the input necessary for determining whether or not the counteroffer from the negotiator A is a tentative agreement offer, along with the input of whether or not the counteroffer is acceptable, even on the agreement/tentative agreement confirmation screen image shown in FIG. 7.

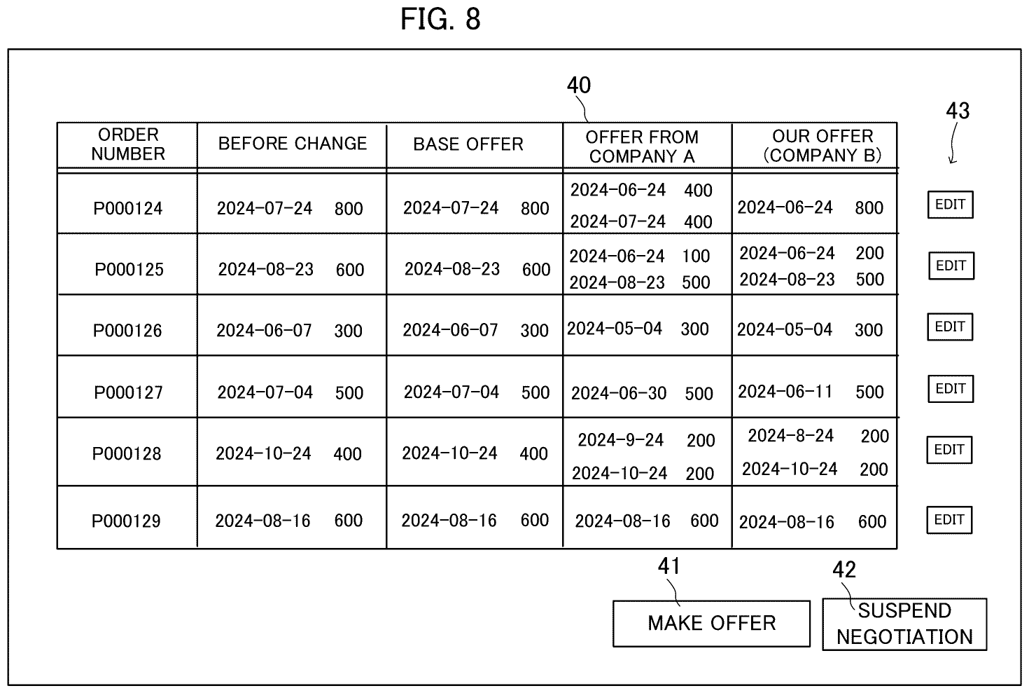

FIG. 8 is an example of an offer edit screen image. Here, the platform providing device 1 displays the offer edit screen image upon detecting the selection of the affirmative button 37B or the negative button 37C on the tentative agreement confirmation screen image shown in FIG. 6, or upon detecting the selection of the second affirmative button 38C or the negative button 38D on the agreement/tentative agreement confirmation screen image shown in FIG. 7.

The platform providing device 1 includes an offer management table 40, an offer determination button 41 denoted by “MAKE OFFER” in this content, a negotiation suspend button 42 denoted by “SUSPEND NEGOTIATION”, and edit buttons 43 provided for respective order numbers on the offer edit screen image shown in FIG. 8.

The offer management table 40 contains records of orders for respective order numbers, and has items “ORDER NUMBER”, “BEFORE CHANGE”, “BASE OFFER”, “PROPOSAL FROM COMPANY A”, and “OUR PROPOSAL (COMPANY B)”. The contents displayed in these items are identical to the contents displayed in the items in the offer display table 38A.

The offer determination button 41 is a button for deciding to notify the counterparty (the negotiator A in this case) of the proposal displayed in the item “OUR OFFER (COMPANY B)” in the offer management table 40 as a counteroffer. The negotiation suspend button 42 is a button for deciding to suspend the negotiations. The edit button 43 is a graphical user interface for editing (input) the offer per order number.

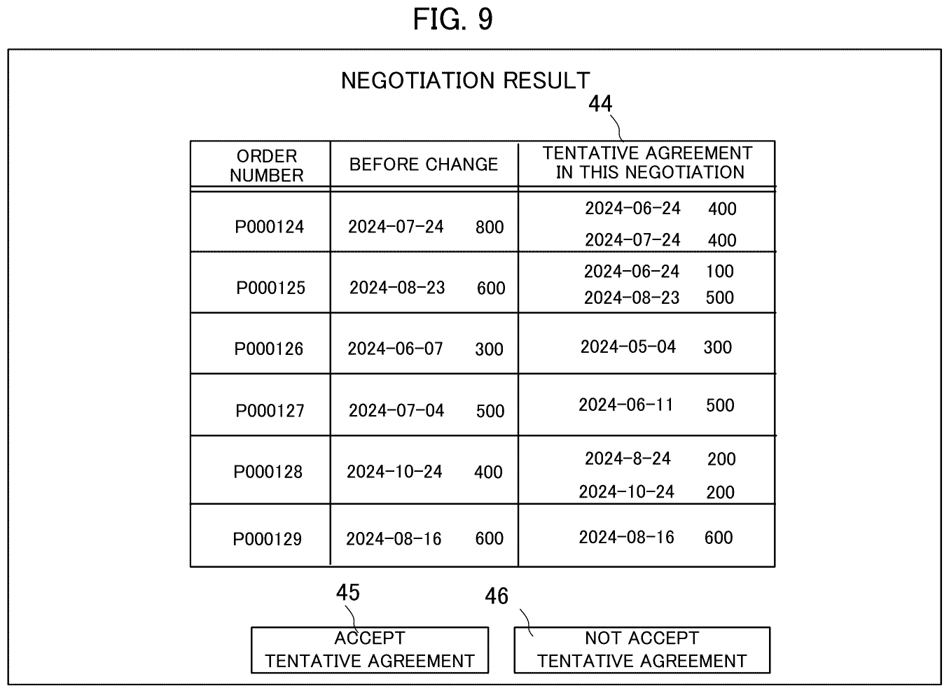

FIG. 9 is an example of a negotiation result screen image displayed on the terminal device 2A. In FIG. 9, the platform providing device 1 detects that the negotiation suspend button 42 is selected in the offer edit screen image and displays the negotiation result screen image shown in FIG. 9 on the terminal device 2A.

The platform providing device 1 provides with a tentative agreement offer display table 44, and an agreement button 45 and a disagreement button 46, which are graphical user interfaces, on the negotiation result screen image shown in FIG. 9.

The tentative agreement offer display table 44 has the following items: “ORDER NUMBER”; “BEFORE CHANGE”; and “TENTATIVE AGREEMENT IN THIS NEGOTIATION”. In the item “TENTATIVE AGREEMENT IN THIS NEGOTIATION”, the latest tentative agreement offer is shown for each order number. In addition, the platform providing device 1 displays the information equivalent to the tentative agreement offer display table 44 on the terminal device 2B. In this manner, the platform providing device 1 presents to the negotiator a final tentative agreement offer as a result of negotiation.

The agreement button 45 is a button for accepting the tentative agreement offer shown in the tentative agreement offer display table 44. Upon detecting that the agreement button 45 has been selected, the platform providing device 1 continues to store information indicating the tentative agreement offer in the negotiation information storage unit 121 so that the information can be used in the next negotiations. In this case, the tentative agreement offer is used as the base offer for the next negotiations.

The disagreement button 46 is a button for disagreement on the tentative agreement offer shown in the tentative agreement draft display table 44. Upon detecting that the disagreement button 46 has been selected, the platform providing device 1 deletes information indicating the tentative agreement offer from the negotiation information storage unit 121. In this case, the tentative agreement offer generated in the ongoing negotiations will not be used as a base offer in the next negotiations.

In this way, once the negotiation is suspended, the system makes the final confirmation and obtains consent on the tentative agreement offer to thereby make sure to prevent discrepancy in the handling of the results of the ongoing negotiations. The platform providing device 1 may accept an input that specifies whether or not to agree on the tentative agreement offer through the terminal device 2B and delete the information indicating the tentative agreement offer from the negotiation information storage unit 121 if the platform providing device does not agree on the tentative agreement offer.

### (3-3) Processing Flow

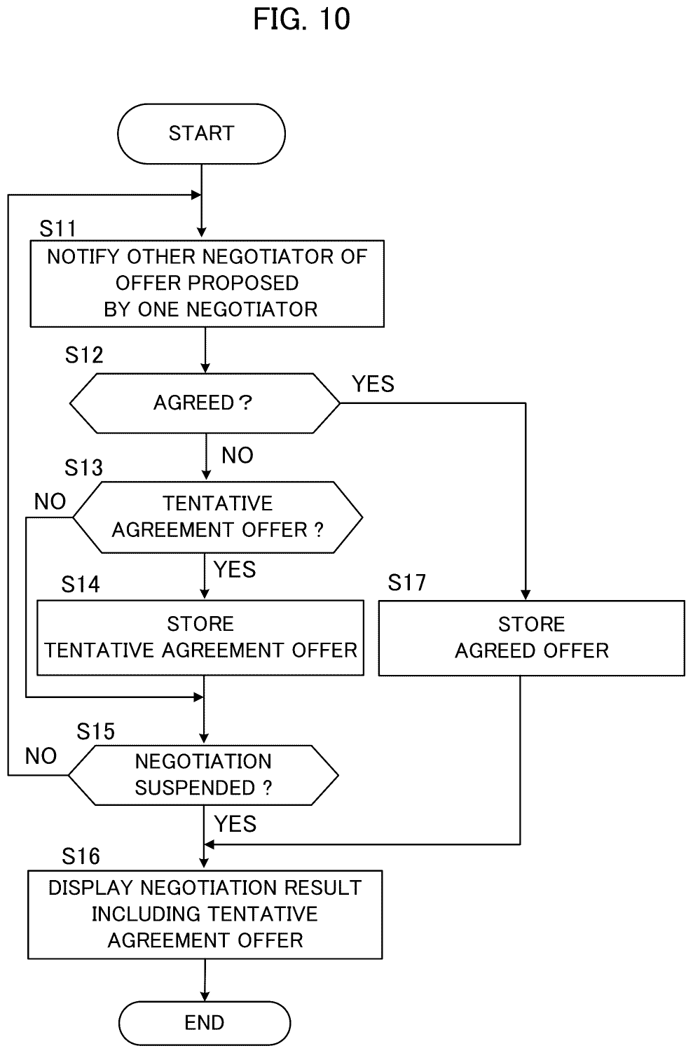

FIG. 10 is an example of a flowchart that is executed by the platform providing device 1 based on input information supplied from the terminal device 2A and the terminal device 2B. Here, the detailed explanation of the process related to the negotiation AI is omitted.

First, the platform providing device 1 notifies the other negotiator of the offer specified by one negotiator (step S11). In this case, if the other negotiator conducts the manual-based negotiations, the platform providing device 1 performs control to display information indicating the offer from the one negotiator on the terminal device 2 used by the other negotiator. On the other hand, if the other negotiator performs the automated negotiations by the negotiation AI, the platform providing device 1 inputs the information indicating the offer to the negotiation AI so that the negotiation AI can make the acceptance determination of the offer or the like.

Next, the platform providing device 1 determines whether or not there is an agreement on the offer (step S12). For example, provided that the other negotiator conducts manual-based negotiations, the platform providing device 1 determines that there is an agreement on the offer upon receiving the input information indicating that the other negotiator has agreed on the offer specified by the one negotiator from the terminal device 2. On the other hand, provided that the other negotiator conducts automated negotiations by the negotiation AI, upon receiving the notification from the negotiation AI that there is an agreement on the offer, the platform providing device 1 determines that there is an agreement on the offer.

Upon determining that there is an agreement on the offer (step S12; Yes), the platform providing device 1 stores the offer as an agreed offer in the negotiation information storage unit 121 (step S17). In this case, for example, the platform providing device 1 stores information indicating the offer agreed between negotiators in the negotiation information storage unit 121 in association with the agreed time information.

On the other hand, upon determining that the offer has been disagreed (step S12; No), the platform providing device 1 determines whether or not the offer specified at step S11 is a tentative agreement offer (step S13). In this case, for example, the platform providing device 1 determines that the offer falls under a tentative agreement offer if the other negotiator at step S11 is the first negotiator who requested the offer in the ongoing negotiations and the offer specified at step S11 is better than the base offer. Upon determining that the offer specified at step S11 is a tentative agreement offer (step S13; Yes), the platform providing device 1 stores the tentative agreement offer in the negotiation data storage unit 121 (step S14). In this case, for example, the platform providing device 1 stores information indicating the tentative agreement offer in the negotiation information storage unit 121 in association with the time information on the tentative agreement. On the other hand, upon determining that the offer specified at step S11 is not a tentative agreement offer (step S13; No), the platform providing device 1 proceeds with the process at step S15.

Next, the platform providing device 1 determines whether or not there is a request for suspend of the negotiations from any of the negotiators (step S15). For example, if the negotiation AI determines that the negotiations should be suspended, or if the platform providing device 1 receives the input information instructing to suspend the negotiations from the terminal device 2, the platform providing device 1 determines that there is a request for suspend of the negotiations. Then, upon determining that there is a request for suspend of the negotiations (step S1; Yes), the platform providing device 1 displays the negotiation result including the latest tentative agreement offer on the terminal device 2A and the terminal device 2B (step S16). In this case, the platform providing device 1 may accept an input as to whether or not to finally agree on the tentative agreement offer.

On the other hand, upon determining that there is no request for suspend of the negotiations from any of the negotiators (step S15; No), the platform providing device 1 proceeds back to the process at step S11. In this case, at step S11, the other negotiator is regarded as the “one negotiator”, and the one negotiator is regarded as the “other negotiator”.

### (4) Modifications

Next, a description will be given of modifications applicable to the example embodiment described above. The following modifications may be applied in any combination.

### (First Modification)

Instead of making manual-based negotiations, the negotiator B may perform automated negotiations using a negotiation AI.

In this instance, the offer generation/update unit 30B and the offer acceptance determination unit 33B shown in FIG. 4 perform acceptance determination, generation, and update of the offer by the negotiation AI instead of performing acceptance determination, generation, and update of the offer based on the input information received from the terminal device 2B. In this instance, the process executed by the offer generation/update unit 30B and the offer acceptance determination unit 33B is the same as the process performed by the offer generation/update unit 30A and the offer acceptance determination unit 33A described with reference to FIG. 4.

Even in this case, by determining and storing a tentative agreement offer, it is possible to suitably reduce the burden of the next negotiations even when the negotiations are suspended.

The negotiator A may conduct manual-based negotiations instead of conducting automated negotiations using a negotiation AI. In this instance, the offer generation/update unit 30A and the offer acceptance determination unit 33A shown in FIG. 4 perform acceptance determination, determination as to a tentative agreement offer, and generation and update of the offer based on the input information received from the terminal device 2A.

### (Second Modification)

The negotiation AI may be executed by the terminal device 2A, instead of being executed by the platform providing device 1.

In this case, the terminal device 2A stores in the memory 22 the model information in place of the model information storage unit 122, and the processor 21 of the terminal device 2A executes the negotiation AI by referring to the model information. Also in this modification, it is possible to suitably realize the automated negotiations for the negotiator A.

### (Third Modification)

The functions of the platform providing device 1 may be incorporated in the terminal device 2.

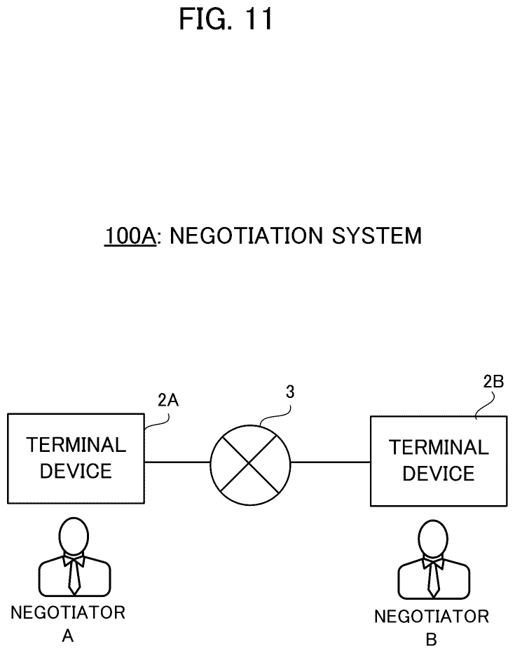

FIG. 11 shows a configuration of a negotiation system 100A. The negotiation system 100A includes a terminal device 2A used by the negotiator A and a terminal device 2B used by the negotiator B. The terminal device 2A and the terminal device 2B performs data communication with each other via the network 3. Then, at least one of the terminal device 2A and/or the terminal device 2B executes the process performed by the platform providing device 1 in FIG. 1 to realize a negotiation platform.

As shown in FIG. 11, even in a mode in which the terminal devices 2 used for negotiations performs data communication with each other, the terminal devices 2 can exchange information necessary for the negotiations to suitably execute the processes related to the notification and acceptance (including a determination as to a tentative agreement offer) of the offer.

### Second Example Embodiment

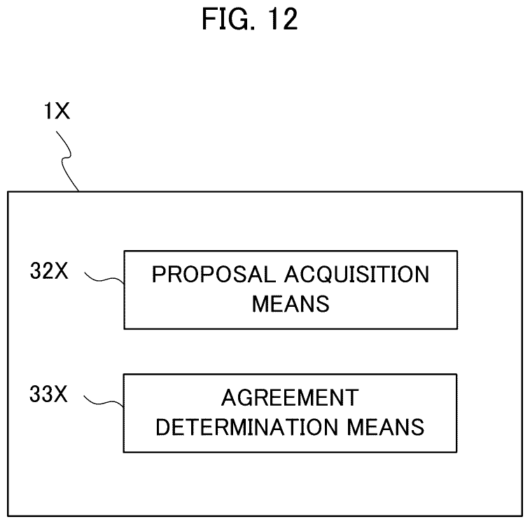

FIG. 12 is a functional block diagram of the agreement determination device 1X. The agreement determination device 1X mainly includes a proposal acquisition means 32X and an agreement determination means 33X. The agreement determination device 1X may be configured by a plurality of devices. Examples of the agreement determination device 1X include the platform providing device 1 shown in FIG. 1, and, the terminal device 2A and/or the terminal device 2B shown in FIG. 11.

The proposal acquisition means 32X is configured to acquire a second proposal provided by a second negotiator as an alternative to a first proposal provided by a first negotiator who conducts a negotiation with the second negotiator. Examples of the proposal acquisition means 32X include the offer receiving unit 32A and the offer receiving unit 32B in the first example embodiment.

The agreement determination means 33X is configured to, upon determining that the second proposal is more favorable for the first negotiator than a base proposal on which the negotiation is based, determine that the second proposal is a tentative agreement proposal which is tentatively agreed between the first negotiator and the second negotiator. Examples of the agreement determination means 33X include the offer acceptance determination unit 33A and the offer acceptance determination unit 33B.

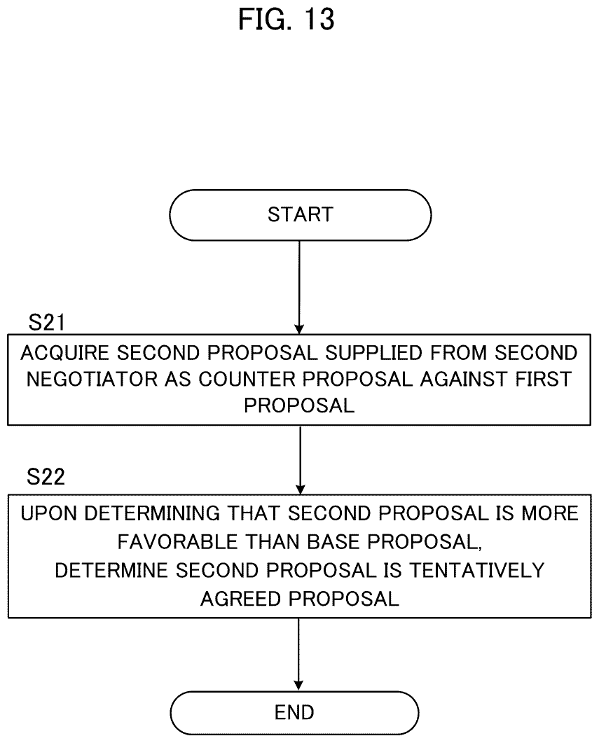

FIG. 13 is an exemplary flowchart executed by the agreement determination device 1X. The proposal acquisition means 32X acquires a second proposal provided by a second negotiator as an alternative to a first proposal provided by a first negotiator who conducts a negotiation with the second negotiator (step S21). Upon determining that the second proposal is more favorable for the first negotiator than a base proposal on which the negotiation is based, the agreement determination means 33X determines that the second proposal is a tentative agreement proposal which is tentatively agreed between the first negotiator and the second negotiator (step S22).

The agreement determination device 1X according to the second example embodiment accurately determines the tentative agreement proposal which is tentatively agreed between the first negotiator and the second negotiator, to suitably reduce the burden of the next negotiation using the determined tentative agreement proposal.

In addition, some or all of the above-described example embodiments (including modifications, the same shall apply hereinafter) may also be described as follows, but are not limited to the following. In addition, some or all of the configurations described in Supplementary Notes 2 to 8 which are dependent on Supplementary Note 1 may be dependent on Supplementary Notes 9 and 10 by the same dependence as Supplementary Notes 2 to 8. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

An agreement determination device comprising:

a proposal acquisition means configured to acquire a second proposal provided by a second negotiator as an alternative to a first proposal provided by a first negotiator who conducts a negotiation with the second negotiator; and

an agreement determination means configured to, upon determining that the second proposal is more favorable for the first negotiator than a base proposal on which the negotiation is based, determine that the second proposal is a tentative agreement proposal which is tentatively agreed between the first negotiator and the second negotiator.

### [Supplementary Note 2]

The agreement determination device according to Supplementary Note 1,

wherein the agreement determination means is configured to determine, based on the base proposal and the second proposal, whether or not the second proposal is more favorable for the first negotiator than the base proposal.

### [Supplementary Note 3]

The agreement determination device according to Supplementary Note 1,

wherein the agreement determination means is configured to
cause a terminal device usable by the first negotiator in the negotiation to display the base proposal and the second proposal, and
receive an input which specifies whether or not the second proposal is more favorable for the first negotiator than the base proposal.

### [Supplementary Note 4]

The agreement determination device according to Supplementary Note 1, further comprising

a display control means configured to, once the negotiation is suspended, cause a first terminal device usable in the negotiation by the first negotiator and a second terminal device usable in the negotiation by the second negotiator to display the tentative agreement proposal, respectively.

### [Supplementary Note 5]

The agreement determination device according to Supplementary Note 1, further comprising

a display control means configured to, once the negotiation is suspended, cause a terminal device usable in the negotiation by the second negotiator to display the tentative agreement proposal and receive an input which specifies whether or not the tentative agreement proposal is acceptable.

### [Supplementary Note 6]

The agreement determination device according to Supplementary Note 1,

wherein, if there are one or more tentative agreement proposals, the latest tentative agreement proposal is set as the base proposal, and

wherein, if there is no tentative agreement proposal, an agreed or tentatively agreed proposal before the negotiation is set as the base proposal.

### [Supplementary Note 7]

The agreement determination device according to Supplementary Note 1,

wherein, upon determining that the first negotiator has disagreed on the second proposal, the agreement determination means is configured to determine whether or not the second proposal is the tentative agreement proposal.

### [Supplementary Note 8]

The agreement determination device according to Supplementary Note 2,

wherein the agreement determination means is configured to determine whether or not the second proposal is more favorable for the first negotiator than the base proposal, based on a first utility on an assumption that the base proposal is employed and a second utility on an assumption that the second proposal is employed.

### [Supplementary Note 9]

An agreement determination method executed by a computer, comprising:
acquiring a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determining that the second proposal is a tentative agreement proposal which is tentatively agreed between the first negotiator and the second negotiator.

### [Supplementary Note 10]

A program executed by a computer, the program causing the computer to:
acquire a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determine that the second proposal is a tentative agreement proposal which is tentatively agreed between the first negotiator and the second negotiator.

### [Supplementary Note 11]

A storage medium storing the program according to Supplementary Note 10.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Platform providing device

1X Agreement determination device

2 (2A, 2B) Terminal device

3 Network

4 Storage device

100, 100A Negotiation system

What is claimed is:

1. An agreement determination device comprising
at least one memory configured to store instructions, and
at least one processor configured to execute the instructions to:
acquire a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determine that the second proposal is a tentative agreement proposal which is tentatively agreed between the first negotiator and the second negotiator.

2. The agreement determination device according to claim 1,
wherein the at least one processor is configured to execute the instructions to determine, based on the base proposal and the second proposal, whether or not the second proposal is more favorable for the first negotiator than the base proposal.

3. The agreement determination device according to claim 1,
wherein the at least one processor is configured to execute the instructions to
cause a terminal device usable by the first negotiator in the negotiation to display the base proposal and the second proposal, and
receive an input which specifies whether or not the second proposal is more favorable for the first negotiator than the base proposal.

4. The agreement determination device according to claim 1,
wherein once the negotiation is suspended, the at least one processor is configured to execute the instructions to cause a first terminal device usable in the negotiation by the first negotiator and a second terminal device usable in the negotiation by the second negotiator to display the tentative agreement proposal, respectively.

5. The agreement determination device according to claim 1,
wherein once the negotiation is suspended, the at least one processor is configured to execute the instructions to cause a terminal device usable in the negotiation by the second negotiator to display the tentative agreement proposal and receive an input which specifies whether or not the tentative agreement proposal is acceptable.

6. The agreement determination device according to claim 1,
wherein, if there are one or more tentative agreement proposals, the latest tentative agreement proposal is set as the base proposal, and
wherein, if there is no tentative agreement proposal, an agreed or tentatively agreed proposal before the negotiation is set as the base proposal.

7. The agreement determination device according to claim 1,
wherein, upon determining that the first negotiator has disagreed on the second proposal, the at least one processor is configured to execute the instructions to determine whether or not the second proposal is the tentative agreement proposal.

8. The agreement determination device according to claim 2,
wherein the at least one processor is configured to execute the instructions to determine whether or not the second proposal is more favorable for the first negotiator than the base proposal, based on a first utility on an assumption that the base proposal is employed and a second utility on an assumption that the second proposal is employed.

9. An agreement determination method executed by a computer, comprising:
acquiring a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determining that the second proposal is a tentative agreement proposal which is tentatively agreed between the first negotiator and the second negotiator.

10. A non-transitory computer readable storage medium storing a program executed by a computer, the program causing the computer to:
acquire a second proposal provided by a second negotiator as an alternative to a first proposal provided by a first negotiator who conducts a negotiation with the second negotiator; and
upon determining that the second proposal is more favorable for the first negotiator than a base proposal on which the negotiation is based, determine that the second proposal is a tentative agreement proposal which is tentatively agreed between the first negotiator and the second negotiator.
